(19) United States
(12) Patent Application Publication
(10) Pub. No.: US 2013/0201717 A1
(43) Pub. Date: Aug. 8, 2013

(54) LAMPSHADE WITH TAPERED LIGHT GUIDE

(71) Applicant: Robert L. Holman, Evanston, IL (US)

(72) Inventor: Robert L. Holman, Evanston, IL (US)

(73) Assignee: QUALCOMM MEMS TECHNOLOGIES, INC., San Diego, CA (US)

(21) Appl. No.: 13/368,912

(22) Filed: Feb. 8, 2012

(51) Int. Cl. G09F 13/18; F21V 17/00

(52) U.S. Cl. 362/602; 29/428

(57) ABSTRACT

This disclosure provides systems, methods and apparatus for illumination. In one aspect, a lampshade includes a light source coupled to a tapered light guide sheet. The light guide sheet extends laterally and is curved around a vertical axis. The light source injects light into the wide end of the tapered light guide sheet and the tapered sidewalls of the light guide sheet allow the light to escape out of the light guide sheet and in the general direction of the narrow end of the tapered light guide sheet, thereby allowing the lampshade to act as an up-light or down-light, depending on the direction that the narrow end is pointing. The lampshade may include light extracting and turning features and/or a reflector configured to eject light laterally outward from the light guide sheet, thereby allowing the lampshade to illuminate objects on the same plane as the lampshade.

### TECHNICAL FIELD

This disclosure relates to lighting fixtures and more particularly to lampshades and systems utilizing lampshades. This disclosure also relates to methods of fabricating the lighting fixtures.

### DESCRIPTION OF THE RELATED TECHNOLOGY

The illumination of spaces, such as rooms, may be accomplished using lamps. Conventional lamps used in residential and commercial applications, for example, table and floor lamps, hanging lamps, and wall-mounted lamps, may be large and heavy, and relatively inefficient in converting electricity to light.

Recently, lighting fixtures utilizing light emitting diodes (LEDs) have been used for their lighter and more compact packaging, and higher efficiency. However, LEDs typically have hemispherically-directed light output from very concentrated points or spots of intense brightness compared to the large area, omni-directional, relatively comfortably diffused emission from traditional light sources such as incandescent bulbs or fluorescent bulbs. The intense brightness concentration of LED output can limit the use of LEDs for general lighting applications.

Accordingly, new lighting fixtures, some including LEDs, are continually being developed that overcome such limitations.

### SUMMARY

The systems, methods and devices of the disclosure each have several innovative aspects, no single one of which is solely responsible for the desirable attributes disclosed herein.

One innovative aspect of the subject matter described in this disclosure can be implemented in a lampshade. The lampshade includes a light source and a light guide sheet extending laterally and curved around a vertical axis. The light guide sheet includes a first vertical end coupled to the light source and a second vertical end opposite the first vertical end. The light guide sheet has a varying thickness that decreases from the first vertical end to the second vertical end. The light guide sheet can be configured to guide light through the light guide sheet by total internal reflection (TIR). The lampshade can include light extracting and turning features configured to eject light laterally outwards from the lampshade. A reflector may be disposed adjacent to an inner surface of the light guide sheet to aid in ejecting light outwards from the lampshade.

Another innovative aspect of the subject matter described in this disclosure can also be implemented in a lampshade. The lampshade includes a light source and means for guiding light by total internal reflection. The means for guiding light by total internal reflection ejects light out of one or more major sides of the means in a direction generally opposite the light source. The means for guiding light can include a light guide sheet having a first vertical end coupled to the light source and a second vertical end opposite the first vertical end. The light guide sheet may have a varying thickness that decreases from the first vertical end to the second vertical end. The light guide sheet may be curved around a vertical axis.

Another innovative aspect of the subject matter described in this disclosure can be implemented in a method of manufacturing a lampshade. The method includes providing a vertically tapered body of light propagating material and providing a light source. The vertically tapered body of light propagating material is curved around a vertical axis and supports propagation of light through a length of the body. The light source is disposed at a wide end of the vertically tapered body.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is an example of a cross section of a lampshade.

FIG. 2A is an example of a cross section of the light guide sheet of FIG. 1 in isolation.

FIG. 2B illustrates an example of the path of a light ray propagating through the light guide sheet of FIG. 2A.

FIG. 2C is an example of the near field profile of light emitted from the light guide sheet of FIGS. 2A and 2B.

FIG. 3A is an example of a cross section of a lampshade having light extracting and turning features.

FIG. 3B is an example of a perspective view of a lampshade having light extracting and turning features.

FIG. 4 is an example of a cross section of a lampshade having light extracting and turning features and a reflector.

FIG. 5A is an example of a perspective view of a light guide sheet that extends laterally to form a continuous loop.

FIG. 5B is an example of a perspective view of a curved light guide sheet that does not form a continuous loop.

FIG. 6A is an example of a cross section of a lampshade having a substantially conical shape.

FIG. 6B is an example of a perspective view of a lampshade having a substantially conical shape.

FIG. 6C is another example of a perspective view of a lampshade having a substantially conical shape.

FIG. 6D is an example of a perspective view of a lampshade having a substantially cylindrical shape.

FIG. 6E is another example of a perspective view of a lampshade having a substantially cylindrical shape.

FIG. 7 shows an example of a flow diagram illustrating a manufacturing process for a lampshade.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. For example, the teachings may be applied to provide lighting fixtures or illumination systems. The teachings are not intended to be limited to the implementations depicted solely in the Figures, but instead have wide applicability as will be readily apparent to a person having ordinary skill in the art.

Some implementations disclosed herein include a lampshade with a tapered light guide sheet coupled to a light source. The light guide sheet tapers so that its thickness decreases from a first vertical end to a second vertical end. In some implementations, the taper defines a wedge-like shape and the sidewalls of the light guide sheet are non-parallel. The light source is coupled to the wider first vertical end and injects light into that end. At least a portion of the injected light propagates through the light guide sheet by total internal reflection (TIR) off of the light guide sheet's sidewalls. Because the sidewalls are not parallel, the angle of incidence of the light impinging on the sidewalls progressively changes after each reflection, such that some of the light is ultimately incident on the sidewalls at angles outside of the range of angles for TIR and, thus, escapes out of the light guide sheet. This escaped light propagates away from the light guide sheet in the general direction of the narrower end of the light guide sheet, thereby allowing the lampshade to function as a downlight or an uplight, depending on the orientation of the lampshade. In some implementations, the lampshade can also include light extracting and turning features and/or a reflector. The light extracting and turning features may eject light laterally outwards at an oblique angle from the bounding plane of the light guide sheet and may provide a diffuse “glow” in some implementations. Light propagating toward the center of the lampshade may be redirected by the reflector out of the lampshade to the ambient environment for illumination.

Particular implementations of the subject matter described in this disclosure can be implemented to realize one or more of the following potential advantages. For example, light emitted from a highly concentrated point or spot light source (such as a light emitting diode (LED)) can be directed within the surface and out from the surface of a lampshade in a controlled manner (e.g., downwards, upwards, and/or laterally out of the lampshade) for illumination. The light emission may be controlled by the taper of the light guide forming the lampshade and/or using light extracting and turning features. The task area under (or above) the lampshade may be illuminated directional lighting applications (for example, a spotlight or floodlight), and the lampshade surface can provide a more diffuse “glow.” As a result, highly efficient concentrated surface area light sources, such as LED's, can be utilized to provide various controlled wide area light emission distributions for general ambient illumination applications. In some implementations, the lampshades may look similar to some conventional lampshades surrounding conventional wide-angle light bulbs and, in some implementations, may be configured such that they can be installed in traditional lamp bases as a conventional lampshade would be installed. As a result, the lampshades may be easily retrofitted on existing lamp bases. In some implementations, the lampshade may be configured so that it can screw into a traditional electrical socket (e.g., female Edison socket) of any conventional lamp base made for incandescent bulbs such that it receives conventional electrical power through its connection. In some implementations, an ac-to-dc power converting electronic circuit can be built into the connection to provide dc power to the lampshades LEDS.

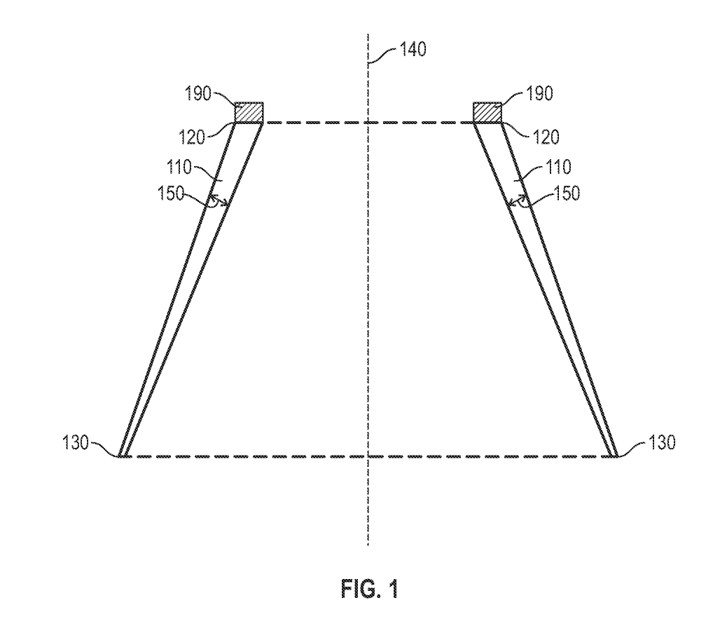

FIG. 1 is an example of a cross section of a lampshade. The lampshade includes a light guide sheet 110 and a light source 190. The light guide sheet 110 extends laterally and curves around a vertical axis 140. The light guide sheet 110 includes a first vertical end 120 and a second vertical end 130 opposite the first vertical end 120. In cross-section, the light guide sheet 110 has a varying thickness 150 that decreases from the first vertical end 120 to the second vertical end 130. The first vertical end 120 is coupled to the light source 190. As illustrated, the light source 190 may be oriented with a light output surface of the light source 190 directly facing the first vertical end 120. In some implementations, the light source 190 may be mechanically attached (for example, using screws, or other mechanical or adhesive fasteners) to the first vertical end 120 and/or adhered to the first vertical end 120 with an optically transmissive adhesive. In some other implementations, an intermediate light guide (not shown) may be provided to propagate light between the light source 190 and the first vertical end 120. The light source 190 can include any light emitter that can inject light into the first vertical end 120. For example, the light source 190 can include a surface-emitting element such as a light emitting diode (LED). In some other implementations, the light source 190 can include, for example, a fluorescent lamp, or a light bar configured to inject light into the first vertical end 120. In some implementations, the light source 190 can be a single continuous light emitter that, for example, extends substantially an entire length of the first vertical end 120 (for example, forming a ring), or a plurality of spaced-apart light emitters, which may be disposed along the length of the first vertical end 120.

The light guide sheet 110 may be made of an optically transmissive material. For example, the light guide sheet 110 can be formed of one or more of the following materials: acrylics, acrylate copolymers, ultraviolet (UV)-curable resins, polycarbonates, cycloolefin polymers, polymers, organic materials, inorganic materials, silicates, alumina, sapphire, glasses, polyethylene terephthalate (“PET”), polyethylene terephthalate glycol (“PET-G”), poly methyl methacralate (“PMMA”), silicon oxy-nitride, and/or other optically transparent materials.

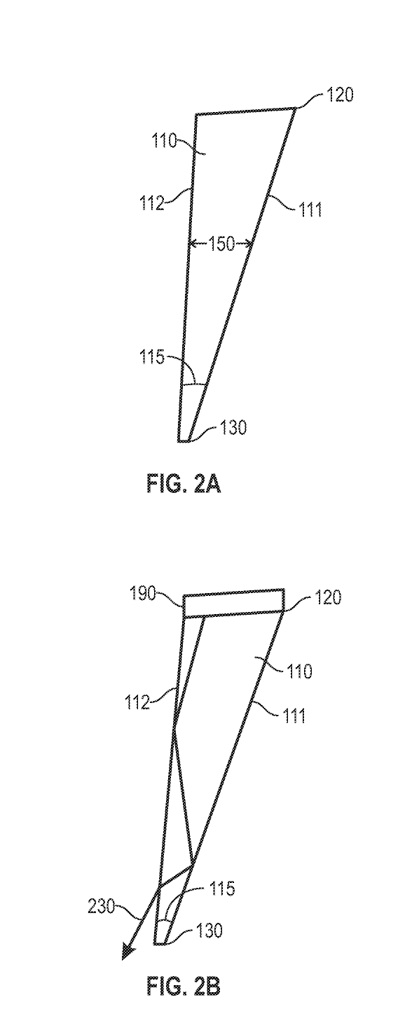

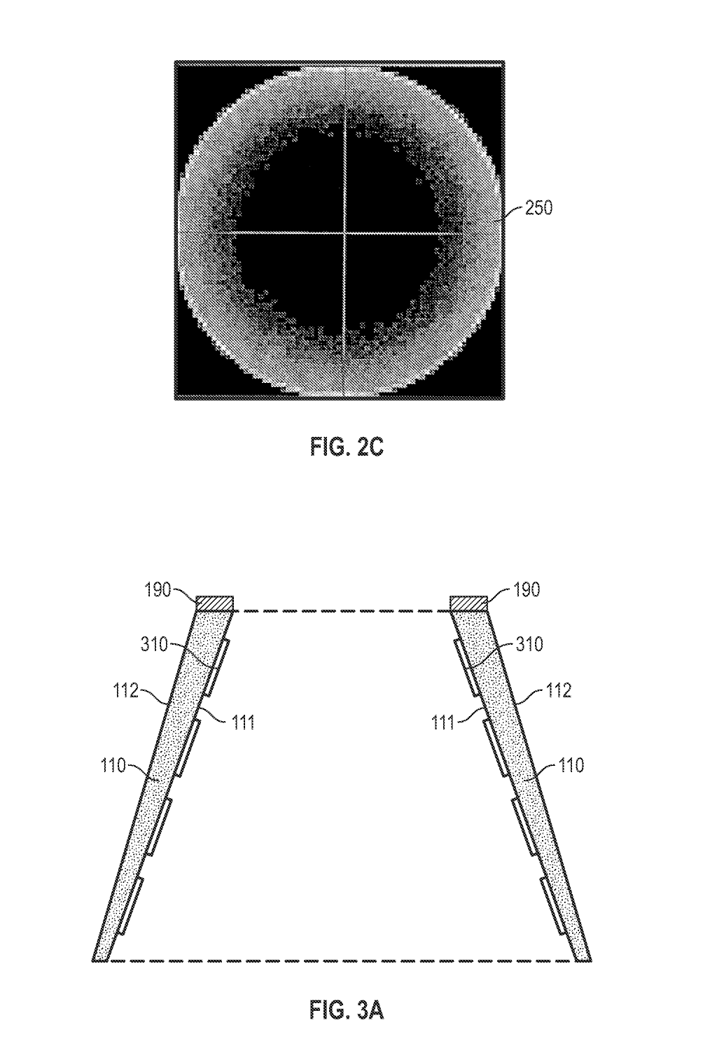

FIG. 2A is an example of a cross section of the light guide sheet 110 of FIG. 1 in isolation. As illustrated, the varying thickness 150 of the light guide sheet 110 may define a substantially wedge-like shape. The shape of the light guide sheet 110 may be wider at the first vertical end 120 and taper toward the second vertical end 130 as shown in FIG. 2A. In some implementations, the cross section of the light guide sheet 110 may have the shape of a triangle that is truncated at the second vertical end 130. In some other implementations, the second vertical end 130 can be the sharp tip of a triangle. The light guide sheet 110 includes an inner side surface 111 and an outer side surface 112 which are non-parallel and define a taper angle 115.

FIG. 2B illustrates an example of the path of a light ray propagating through the light guide sheet of FIG. 2A. The near field light distribution at the bottom of the tapered lampshade (the second vertical end 130 of FIG. 1) is shown and, in some implementations, is representative of the combined paths of all light rays propagating through the light guide sheet 110 of FIG. 2A. As shown in FIG. 2B, the light source 190 may inject a light ray 230 into the light guide sheet 110 as one illustrative ray. The light guide sheet 110 may be configured to guide light through the light guide sheet 110 by total internal reflection (TIR). One of ordinary skill in the art will appreciate that total internal reflection may occur when a ray of light propagating through a first medium strikes the boundary with second medium. Without being limited by theory, it is generally understood that if the refractive index of the second medium is lower than the refractive index of the first medium and the incident angle of the ray of light on the boundary is greater than a critical angle for the particular media, then no light passes through and all of the light is reflected. As measured from the normal to the boundary, the critical angle is the angle of incidence above which total internal reflection occurs. Below the critical angle, at least a portion of the light incident on the boundary may escape the first medium. In this manner, some light rays exit light guide sheet 110 at its tapered end 130 while rays that fail total internal reflection may pass through the tapered sidewalls 111 and/or 112 of the light guide sheet 110.

With continued reference to FIG. 2B, the light guide sheet 110 may be considered to be the first medium and the surrounding ambient may be considered to be the second medium. For example, the second medium may be air. In some implementations, the light guide sheet 110 may be provided with an optically transmissive material (for example, a protective coating) on its surfaces. To facilitate TIR within the light guide sheet 110, the optically transmissive material may have a lower refractive index than the refractive index of the light guide sheet 110 (for example, about 0.05 or more, or about 0.1 or more lower than the refractive index of the light guide sheet 110).

Due to the taper of the light guide sheet 110 and the dependence of TIR on the angle of incidence of light being above the critical angle, the light guide sheet 110 can allow light to escape obliquely to the sidewall 111 of the light guide substantially in the direction of the second vertical end 130. As light propagates through the light guide sheet 110 by TIR, having the sidewalls 111 and 112 at an angle relative to each other progressively changes the angle of incidence of the light striking each sidewall, as shown in FIG. 2B. As the light progresses through the light guide sheet 110, some of the light (e.g., light ray 230) eventually has an angle of incidence below the critical angle, thereby allowing it to escape TIR and to propagate out of the light guide sheet 110 through one or both of the sidewalls 111 and 112. In addition, due to refraction, the escaped light typically propagates away from the light guide sheet 110 in the general direction of the narrower end of the light guide sheet 110.

With continued reference to FIG. 2B, the taper angle 115 may cause light to be ejected by allowing the light to escape TIR in a controlled fashion. The taper angle 115 may be selected for a desired lighting effect. For example, increasing the taper angle 115 may result in wider ring of extracted light in the far field, while decreasing the taper angle 115 may result in a more concentrated ring of far field light. In some implementations, the taper angle 115 is in the range of about 2-15 degrees. In some implementations, the taper angle 115 may be about 15 degrees or less, about 10 degrees or less, about 7 degrees or less, or about 5 degrees or less.

FIG. 2C is an example of the near field profile of light emitted from the light guide sheet of FIGS. 2A and 2B. As a result of light escaping TIR, light may propagate within a small band of angles in directions generally towards the second vertical end 130. This can produce a “ring” of light 250 on a surface facing the second vertical end 130. Thus, a spot light or task surface lighting effect may be produced. In some implementations where the second vertical end 130 faces downwards, the lampshade (FIG. 1) may be used as a downlight or a task light and in some other implementations where the second vertical end 130 faces upwards, the lampshade maybe used as an uplight.

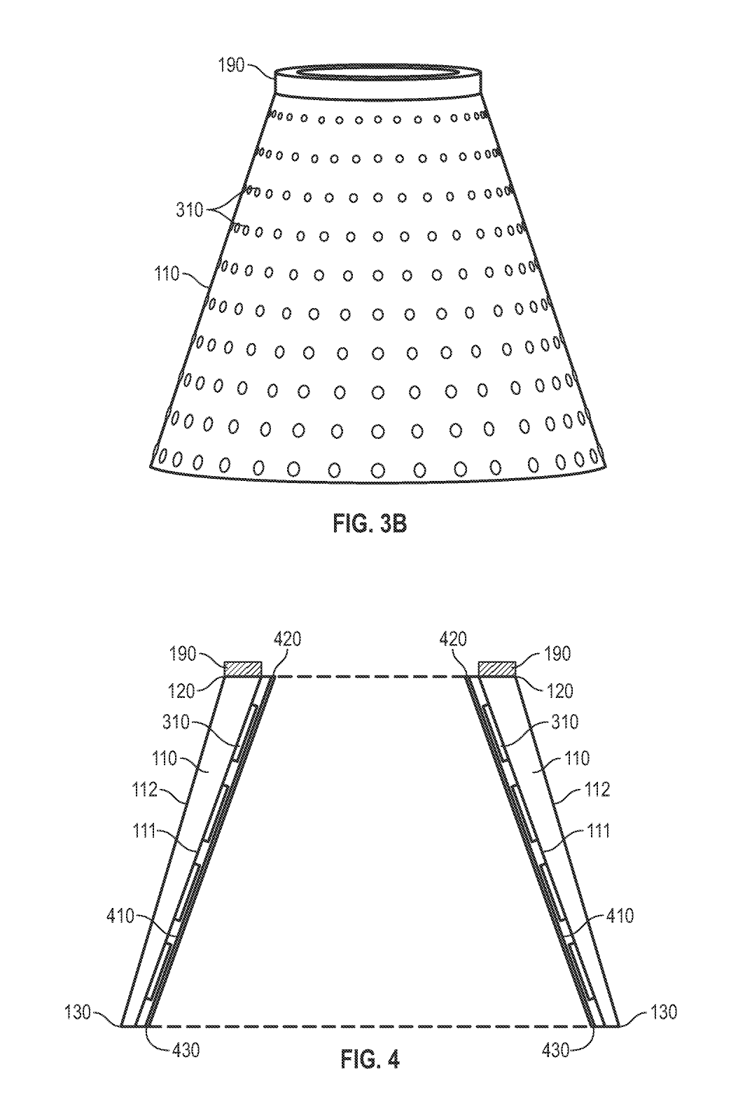

In some implementations, the lampshade may be configured to eject light laterally outward from the sidewall 112 of the light guide sheet 110. Such light ejection may also be referred to as light extraction and may be accomplished using light extracting and turning features, which may also include a plane reflector or diffuser. FIG. 3A is an example of a cross section of a lampshade having light extracting and turning features 310. FIG. 3B is an example of a perspective view of a lampshade having light extracting and turning features 310. In some implementations, the light extracting and turning features 310 may be disposed along one or both of the inner surface 111 and the outer surface 112, and/or disposed within the body of the light guide sheet 110. As illustrated, the light extracting and turning features 310 may be disposed along the inner surface 111 of the light guide sheet 110, which may allow the formation of a smooth outer surface 112.

The light-turning features 310 may take the form of any feature configured to eject light out of the light guide sheet 110 and direct light in one or more angular directions. For example, the light-turning features 310 may include recesses formed on one or both of the inner surface 111 and the outer surface 112. In some implementations, the recesses may be spherically-shaped or conically-shaped. The sides of the recesses may be reflective and angled to eject light out of the light guide sheet 110. For example, air or other material filling the recesses may allow reflection by TIR, or the recesses may be coated with a reflective coating (such as a reflective metallic coating). In some other implementations, the light ejecting and turning features 310 may include one or more layers of different materials as coating(s) on one or both of the inner surface 111 and the outer surface 112. In some implementations, the coatings may be painted or deposited on one or both of the inner surface 111 and the outer surface 112 so as to create a localized light scattering property. In some other implementations, the light extracting and turning features 310 may include holographic features formed as part of a holographic layer.

With reference to FIG. 3B, the light extracting and turning features 310 may be disposed throughout the light guide sheet 110. In some implementations, the light extracting and turning features 310 may be disposed regularly or evenly across the light guide sheet 110. Because the intensity of light in the light guide sheet 110 can decrease with distance from the light source 190 due to more and more of the light being ejected by the light extracting and turning features 310 as it travels through the light guide sheet, the light extracting and turning features 310 may be configured to increase their light turning efficiency with distance from the light source 190. For example, the size and/or density of the light extracting and turning features 310 may increase with distance from the light source 190, to provide a roughly uniform ejection of light over the light guide sheet 110. As another example, the size and/or density of the light extracting and turning features may be mathematically varied to produce a particularly patterned glow, so as to seem to have been the result of the effect of a centrally positioned incandescent bulb mounted within the interior volume of the lampshade of FIG. 3A.

In some implementations, the light extracting and turning features 310 may be visible to an observer because of the deliberate fraction of their transmission of extracted light. For example, the light extracting and turning features 310 may form a desired arbitrary pattern. In some implementations, the desired pattern may be chosen to provide a desired type of illumination, such as a diffuse flow where the light ejection is uniform, or a visible geometric pattern. In some implementations, the light extracting and turning features 310 may be arranged to form logos, words, lettering, and/or artistic arrangements, etc.

FIG. 4 is an example of a cross section of a lampshade having light extracting and turning features and a reflector. In some implementations, a reflector 410 may also be formed adjacent to an inner surface 111 of the light guide sheet 110. The reflector 410 may provide specular and/or diffuse reflection. The reflector 410 may be provided to redirect any light propagating towards the inside of the lampshade back into turning the light guide sheet 110. For example, the light extracting and turning features 310 may be configured to direct light towards the reflector 410, which then reflects the light out of the lampshade through the light guide sheet 110. As such, the lampshade may produce a diffusive glow. In some implementations, the reflector 410 may include a diffusive reflector. The reflector 410 may reflect substantially all incident light or may be partially reflective and partially transmissive.

In some implementations, the reflector 410 may also include a sheet that is tapered, such that it is widest in thickness at the bottom of the lampshade and decreases gradually to be narrowest in thickness at the top of the lampshade. In some implementations, due to their mutually tapering cross sections, the aggregate thickness of the light guide sheet 110 and the reflector 410 may be roughly constant over the height of the lampshade. In some other implementations, the lampshade may further include a reflector 410 disposed adjacent to an inner surface 111 of the light guide sheet 110. In some implementations, the reflector 410 may include a sheet having a varying thickness that decreases from a first end 420 proximate the first vertical end 120 of the light guide sheet 110 to a second end 430 proximate the second vertical end 130 of the light guide sheet 110.

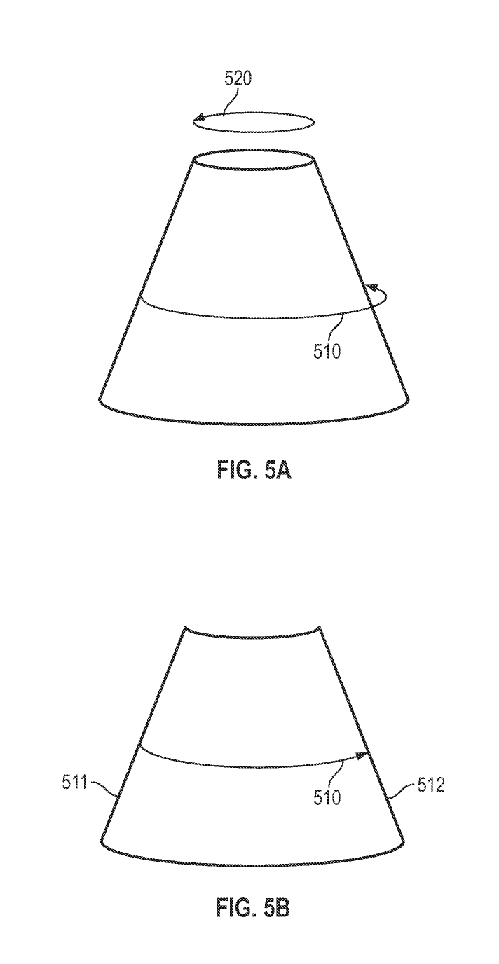

As illustrated in FIGS. 5A-5B, the light guide sheet 110 may take a variety of shapes. FIG. 5A is an example of a perspective view of a light guide sheet that extends laterally to form a continuous loop. FIG. 5B is an example of a perspective view of a curved light guide sheet that does not form a continuous loop. In some implementations, the light guide sheet 110 may extend laterally along a lateral axis 510 to form a continuous loop 520 of material. In some implementations, the continuous loop 520, may form a substantially smooth curve (such as a circle) as illustrated in FIG. 5A. In other implementations, the light guide sheet 110 may extend laterally 510 and terminate before forming a continuous loop, as illustrated in FIG. 5B. Such a shape may be used to form light fixtures such as sconces, or similar fixtures. Because light may leak from the lateral edges 511 and 512 where the light guide sheet terminates, in some implementations, those edges may be provided with an opaque and/or reflective material to prevent the light leakage.

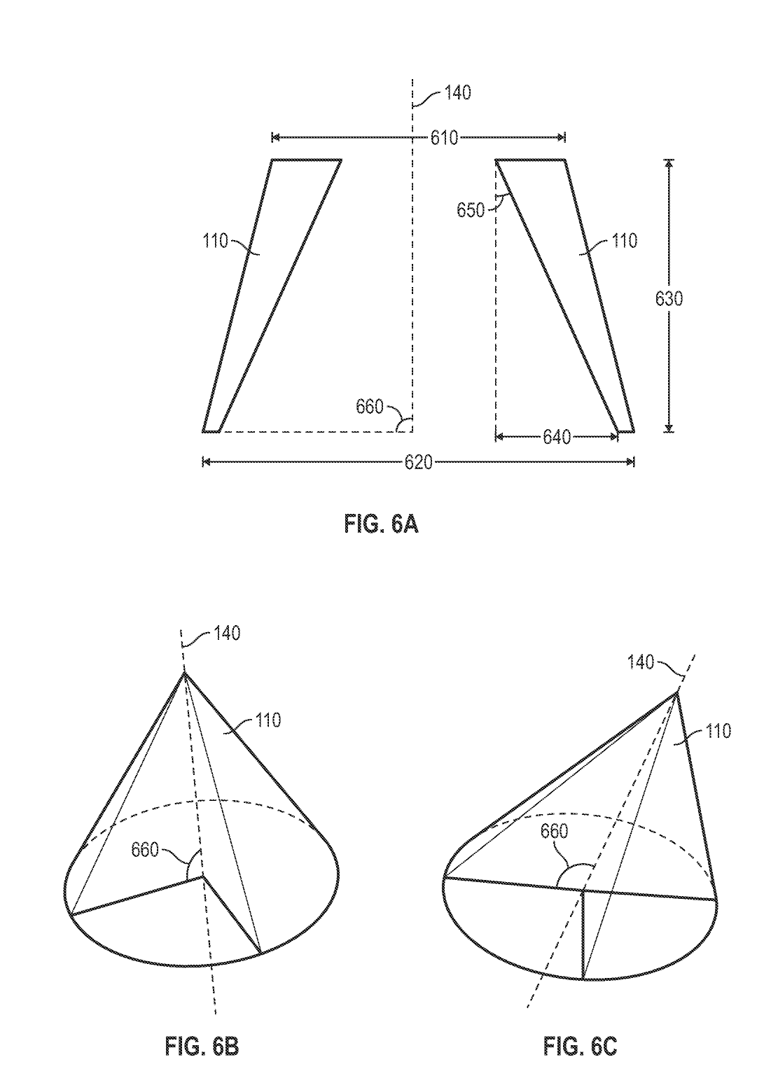

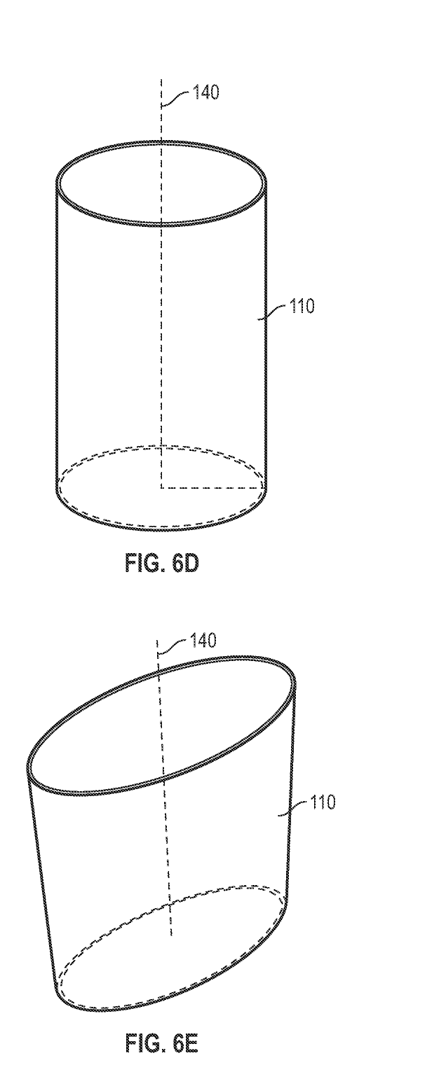

With reference to FIGS. 6A to 6E, the light guide 110 may define various shapes. FIG. 6A is an example of a cross section of a lampshade having a substantially conical shape. Certain dimensions of the light guide may be varied for geometrical and/or architectural design, such as an upper diameter 610, a lower diameter 620, a height 630, a length 640, a vertex angle 650, and an angle 660 relative to the vertical axis 140. In some implementations, the lower diameter 620 is larger than the upper diameter 610, such that the lampshade has a generally conical shape. In some other implementations, the lower diameter 620 is substantially similar to, or smaller than the upper diameter 610.

FIG. 6B is an example of a perspective view of lampshade having a substantially conical shape. FIG. 6C is another example of a perspective view of a lampshade having a substantially conical shape. In some implementations, the vertical axis 140 may pass at an angle 660 perpendicular through the center of the base. In other implementations, the vertical axis 140 may pass through the center of the base at an angle 660 to form an oblique cone. While shown forming a pointed tip for ease of illustration and description, the lampshade may take the form of a truncated cone as shown in FIGS. 5A and 5B.

As noted herein, in some other implementations, the lower diameter 620 may be substantially similar to the upper diameter 610 such that the lampshade has a substantially cylindrical shape. FIG. 6D is an example of a perspective view of a lampshade having a substantially cylindrical shape and FIG. 6E is another example of a perspective view of a lampshade having a substantially cylindrical shape. In some implementations, the substantially cylindrical light guide sheet may be an elliptic cylinder, parabolic cylinder, or hyperbolic cylinder.

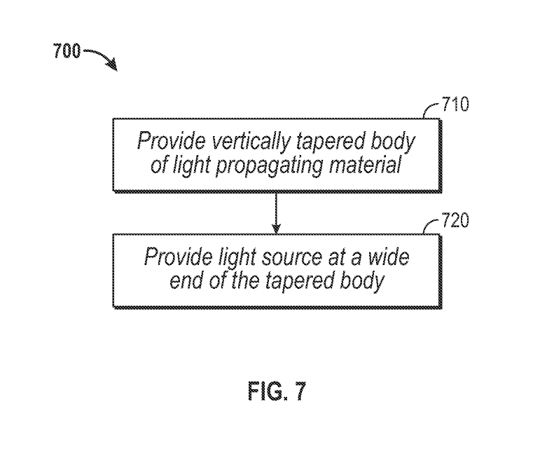

The lampshade may be formed by various methods. FIG. 7 shows an example of a flow diagram illustrating a manufacturing process for a lampshade. Process 700 can include a block 710 that includes providing a vertically tapered body of light propagating material curved around a vertical axis, the material supporting propagation of light through a length of the body. The process 700 then transitions to block 720. At block 720, a light source may be provided and disposed at a wide end of the vertically tapered body. Providing the vertically tapered body at block 710 can include forming a plurality of light extracting and turning features on a side surface of the tapered body. Providing the light source at block 720 can include attaching at least one light emitting diode to the wide end of the tapered body. The process can also include attaching a reflector adjacent to an inner surface of the tapered body. In some implementations, the vertically tapered body extends laterally to form a continuous loop. In some implementations, a shape defined by the loop is substantially cylindrical.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, words of relative orientation, such as the terms “upper” and “lower,” are sometimes used for ease of describing the figures, and indicate relative positions corresponding to the orientation of the figure on a properly oriented page, and may not reflect the proper orientation of the lampshade as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A lampshade comprising:
a light source; and
a light guide sheet extending laterally and curved around a vertical axis, the light guide sheet including a first vertical end coupled to the light source and a second vertical end opposite the first vertical end,
wherein the light guide sheet has a varying thickness that decreases from the first vertical end to the second vertical end.

2. The lampshade of claim 1, wherein a shape defined by the varying thickness of the light guide sheet is substantially wedge-like.

3. The lampshade of claim 2, wherein the light guide sheet includes an inner side surface and an outer side surface which define a taper angle of about 10 degrees or less.

4. The lampshade of claim 1, wherein the light guide sheet extends laterally to form a continuous loop.

5. The lampshade of claim 4, wherein a shape defined by the light guide sheet is substantially cylindrical.

6. The lampshade of claim 4, wherein a shape defined by the light guide sheet is substantially conical.

7. The lampshade of claim 1, wherein the light source includes a light emitting diode.

8. The lampshade of claim 1, wherein the light guide sheet is configured to eject light out of the light guide sheet substantially in a direction of the second vertical end.

9. The lampshade of claim 1, wherein the light guide sheet is configured to guide light through the light guide sheet by total internal reflection (TIR).

10. The lampshade of claim 1, further comprising a plurality of light extracting and turning features on a side surface of the light guide sheet.

11. The lampshade of claim 10, wherein the light extracting and turning features are configured to eject light laterally outwards from the light guide sheet.

12. The lampshade of claim 1, further comprising a reflector disposed adjacent to an inner surface of the light guide sheet.

13. The lampshade of claim 12, wherein the reflector includes a sheet having a varying thickness that increases from a first end proximate the first vertical end of the light guide sheet to a second end proximate the second vertical end of the light guide sheet.

14. A lampshade comprising:
a light source; and
means for guiding light by total internal reflection and for ejecting light out of one or more major sides of the means in a direction generally opposite the light source.

15. The lampshade of claim 14, wherein the light guided by total internal reflection has an angle of incidence when impinging on the major sides, wherein the means for guiding light is configured to progressively change the angle of incidence of the light guided by total internal reflection, wherein ejecting the light occurs when the angle of incidence of the light is below a critical angle for total internal reflection.

16. The lampshade of claim 14, wherein the means for guiding light includes a light guide sheet having a first vertical end coupled to the light source and a second vertical end opposite the first vertical end, wherein the light guide sheet has a varying thickness that decreases from the first vertical end to the second vertical end, wherein the light guide sheet is curved around a vertical axis.

17. The lampshade of claim 16, wherein a shape defined by the light guide sheet is substantially cylindrical.

18. The lampshade of claim 16, further comprising means for ejecting light laterally outwards from the light guide sheet.

19. The lampshade of claim 18, wherein the means for ejecting light laterally includes a plurality of light extracting and turning features on a side surface of the light guide sheet.

20. The lampshade of claim 16, further comprising a means for reflecting light propagating in a direction of an inner surface of the light guide sheet.

21. The lampshade of claim 20, wherein the means for reflecting includes a reflector disposed adjacent to the inner surface.

22. A method of manufacturing a lampshade, comprising:
providing a vertically tapered body of light propagating material curved around a vertical axis, the material supporting propagation of light through a length of the body; and
providing a light source, wherein the light source is disposed at a wide end of the vertically tapered body.

23. The method of claim 22, wherein providing the vertically tapered body includes forming a plurality of light extracting and turning features on a side surface of the tapered body.

24. The method of claim 22, further comprising attaching a reflector adjacent to an inner surface of the tapered body.

25. The method of claim 22, wherein providing the light source includes attaching at least one light emitting diode to the wide end.

26. The method of claim 22, wherein the vertically tapered body extends laterally to form a continuous loop.

27. The method of claim 26, wherein a shape defined by the loop is substantially cylindrical.
